(19) United States
(12) Patent Application Publication
(10) Pub. No.: US 2006/0046119 A1
(43) Pub. Date: Mar. 2, 2006

(54) Surface electrolyte for fuel cell (SEFC)

(76) Inventor: Tihiro Ohkawa, La Jolla, CA (US)

Correspondence Address: NEIL K. NYDEGGER;NYDEGGER & ASSOCIATES, 348 Olive Street, San Diego, CA, 92103, US

(21) Appl. No.: 10/924,446

(22) Filed: Aug. 24, 2004

(51) Int. Cl. H01M 8/10; H01M 4/86; H01M 4/92; H01M 8/02

(52) U.S. Cl. 429/30; 429/40; 429/44; 429/38; 429/13

(57) ABSTRACT

A fuel cell for producing electrical energy includes an electrolyte made of an electro-osmotic material. Specifically, the material is porous silica with pores having diameters around ten nanometers. Further, the electrolyte is formed as a plate having a thickness of approximately fifty microns. A porous silicon anode and a porous silicon cathode are positioned on opposite sides of the plate. A fuel (hydrogen) and an oxidant (oxygen) are directed against the anode and cathode, respectively, to promote electrochemical reactions. Together, these reactions cause protons to be transported through the electrolyte, and electrons to flow through an external circuit, for the production of electrical energy.

### FIELD OF THE INVENTION

The present invention pertains generally to fuel cells. More particularly, the present invention pertains to so-called low-temperature fuel cells that use protons as charge carriers in the electrolyte. The present invention is particularly, but not exclusively useful as a surface electrolyte fuel cell (SEFC) that incorporates a water-filled porous, electro-osmotic electrolyte.

### BACKGROUND OF THE INVENTION

Fuel cells are electrochemical devices that convert the chemical energy of a reaction into electrical energy. Although fuel cells have components and characteristics that are similar to those of a typical battery, they differ in several important respects. Most notably, a battery is an energy storage device, whereas a fuel cell is an energy conversion device. Specifically, fuel cells rely on electrochemical reactions for this energy conversion.

In overview, the structure of a fuel cell includes an anode (negative electrode) and a cathode (positive electrode) that are separated from each other by an electrolyte. Additionally, a catalyst selected from the platinum group metals (e.g. Platinum (Pt) or Ruthenium) can be incorporated to accelerate chemical reactions at each of the respective electrodes. For the operation of a typical fuel cell, a gaseous fuel is continuously fed to the anode of the fuel cell. At the same time, an oxidant is continuously fed to the cathode. Electrochemical reactions that are accelerated by a catalyst, then take place at the respective electrodes to produce an electrical current. There are, of course, a variety of different type fuel cells.

The most common classification of fuel cell types is based on the nature of the electrolyte that is used in the cell. For instance, a polymer electrolyte fuel cell (PEFC) and a phosphoric acid fuel cell (PAFC) are distinguishable because they use different electrolytes. In one (PEFC), the electrolyte is a polymer membrane. In the other (PAFC), the electrolyte is a liquid. In detail, a PEFC fuel cell employs an ion exchange membrane as an electrolyte that may be either a fluorinated sulfonic acid polymer or some other similar polymer. A limitation of the PEFC fuel cell, however, is that it functions only at relatively low operating temperatures (e.g. 80° C.). In large part, this operational limitation is dictated by the nature of the membrane. The consequence here is that the lower operating temperatures require higher catalyst loadings (Pt in most cases). For catalysts such as Pt, this can be expensive. In contrast to PEFC, a PAFC fuel cell employs liquid phosphoric acid as its electrolyte. Although PAFC fuel cells operate at higher, more catalytic efficient temperatures than do PEFC fuel cells (e.g. 200° C.), a limitation in this case is that the phosphoric acid must be immobilized (contained) in a PAFC fuel cell to prevent it from being lost with water.

Although fuel cells are typically categorized by the nature of the electrolyte that is used, they are further distinguished by their operational regimes. Among so-called low-temperature fuel cells (65° C.-220° C.), protons are charge carriers in the electrolyte for PEFC and PAFC, while hydroxyl ions are the charge carriers in AFC (Alkaline Fuel Cell). On the other hand, in high-temperature fuel cells (600° C.-1000° C.), carbonate ions and oxygen ions are the charge carriers. In either case, the ability of the electrolyte to effectively conduct the charge carrier from the anode to the cathode is of crucial importance.

In their general operation, PEFC and PAFC generally rely on the same phenomenon. Specifically, hydrogen is converted to protons at the anode. These protons then enter the electrolyte (membrane or acid) and create a proton concentration gradient across the electrolyte. The resultant concentration gradient then transports the protons through the electrolyte to the cathode. At the cathode, the protons combine with oxygen to produce water. Meanwhile, the electrons that are created at the anode when the hydrogen is converted to protons travel through an external circuit to the cathode.

With the above in mind, consideration is given here for the use of a porous silica material as an electrolyte for a low-temperature fuel cell. To begin this consideration, we model a water channel in the porous silica as a one dimensional channel of width 2d. As is well known, when in contact with water, protons are released from silica plates into water. Thus, the silica plates acquire a surface charge −Σ. With the proton density in water being “n”, the total charge must vanish and we have
∫₀^{d}_{n dx=Σ}
where x is the perpendicular distance from the proton to the plates. The equilibrium density distribution is given by the balance between the electric force and the concentration gradient
n=n₀exp[−eφ/kT]
where φ is the electrostatic potential, k is Boltzmann's constant, and T is the temperature. In this case, it is assumed that φ=0 and n=n₀ at x=0.

The Poisson's equation is then given by
−d²φ/dx²=en/ε
where ε is the dielectric constant. By setting
−eφ/kT=ξ
λ_{D}²=εkT/e²n₀
and
x/λ_{D}=X
we obtain
d²ξ/dX²=exp[ξ].

The solution for the above expression is given by
ξ=−ln[cos²{X/√2}].

From the above it can be shown that not all of the counter ions near the wall of an electro-osmotic material are mobile. Instead, they interact with the wall through van der Waals force and are immobile. In this context, it is customary to define the zeta potential [symbol] as the potential of the layer dividing the mobile and the immobile zones. We then obtain
d/[λ_{D}√2]=cos⁻¹{exp[−e/2kT]}.

For a typical electro-osmotic material, the zeta potential [symbol] is around 0.1 volt at room temperature, and the left hand side of the above equation is close to π/2. By using the definition of λ_{D}, we obtain
n₀=[2εkT/e²d²]{cos⁻¹[exp{−e/2kT}]}².

The average concentration <n>, which is defined by
<n>=[n₀/d]∫₀^{d}exp[ξ]dx
is then given by
<n>=[2εkT/e²d²]{exp[e/kT]−1}^{1/2} cos⁻¹[exp{−e/2kT}].
The mobility μ of proton in water is
μ=4×10⁻⁷ m²/volt sec
and the electric conductivity σ, becomes
σ=eμ<n>.

Using above expressions, we can estimate the conductivity for a condition wherein T=300° K., ε=78 ε₀ and [symbol] =0.1 volt. In doing so, we obtain
<n>=2.1×10⁹/d²
σ=1.3×10⁻¹⁶/d².

It happens that the estimates given above compare favorably with the membrane materials used for PEFC fuel cells. Specifically, typical membranes used in PEFC fuel cells have an electric conductivity of 4 [ohm-m]⁻¹. For the conductivity of silica to have the same value as given by the expression σ=1.3×10⁻¹⁶/d², the pore size 2d in porous silica must be 10 nm. In other words, a silica film with 10 nm pore size will behave similar to the polymer membrane used in a PEFC fuel cell.

In light of the above, it is an object of the present invention to provide a low-temperature fuel cell which incorporates a surface electrolyte such as a porous silica electrolyte plate. It is another object of the present invention to provide a low-temperature monolithic fuel cell that will effectively operate at the relatively higher temperatures (e.g. 200° C.) where lower catalytic loadings are required. Another object of the present invention is to provide a low-temperature monolithic fuel cell having a substantially solid electrolyte that obviates any requirement for the immobilization and containment of a fluid. Still another object of the present invention is to provide a low-temperature monolithic fuel cell that is relatively easy to manufacture, is simple to use and is comparatively cost effective.

### SUMMARY OF THE INVENTION

In accordance with the present invention, a low-temperature fuel cell incorporates a water-filled, electro-osmotic electrolyte. Structurally, the electrolyte is made of a porous silica and is formed as a plate-like structure. Preferably, the material that is used for the electrolyte plate is a porous silica which has pore sizes of approximately 10 nm diameter. Also, the electrolyte plate preferably has a thickness “h” that is greater than approximately fifty microns. The pores of the electrolyte material are filled with water and this plate-like structure is then positioned between an anode and a cathode.

For the present invention, unlike the electrolyte, both the anode and the cathode are made of a conductor material, such as a porous silicon or carbon (graphite). Further, the electrode material is preferably hydrophobic. In combination with the electrolyte plate, the anode is positioned against one side of the electrolyte plate, with a platinum coating positioned therebetween that will serve as a catalyst for electrochemical reactions. Similarly, the cathode is positioned against the other side of the electrolyte plate, opposite the anode. A platinum coating is also positioned between the cathode and the electrolyte plate to serve as a catalyst for electrochemical reactions.

For the operation of the fuel cell of the present invention, a fuel source is provided that will direct fuel (e.g. hydrogen gas) against the anode. At the anode, the fuel enters the pores of the anode and contacts water from the water-filled electrolyte. An electrochemical reaction then takes place between the fuel (hydrogen) and the water to generate protons and electrons. As indicated above, the platinum coating between the anode and the electrolyte plate acts as a catalyst for this electrochemical reaction. The consequence of this reaction is that positive ions (e.g. protons) are generated at the anode. Importantly, these protons then create a concentration gradient across the electrolyte that causes them to be transported through the electrolyte plate to the cathode. At the same time, the electrons are free to move through the conductive material of the anode for use in external circuitry.

An oxidant source is also provided as part of the fuel cell. Specifically, the oxidant source is used to direct an oxidant (e.g. oxygen gas) against the cathode. Consequently, an electrochemical reaction takes place at the cathode including the oxidant (oxygen), electrons from an external circuit, and the positive ions (protons) that are transported through the electrolyte plate. In this case, the platinum coating between the electrolyte plate and the cathode acts as a catalyst for a reaction that involves the oxidation of the positive ions and the creation of water as a waste product. The result of all this is the creation of an electrical potential between the anode and the cathode for the production of electrical energy.

Structurally the fuel source for the present invention includes a metal plate that is positioned against the anode. In particular, this metal plate is formed with a plurality of channels, with each channel having an inlet and an outlet. This metal plate is then positioned with the channels against the anode and with the anode located between the metal plate and the electrolyte plate. Additionally, the fuel source includes a pump for introducing the fuel (hydrogen) into the channels through the respective inlets, and a vent for removing depleted fuel from the outlets of the channels. Similarly, the oxidant source includes a metal plate that is formed with a plurality of channels, with each channel having an inlet and an outlet. This metal plate is then positioned with the channels against the cathode, and with the cathode located between the metal plate and the electrolyte plate. Additionally, the oxidant source includes a pump for introducing the oxidant (oxygen) into the channels through the respective inlets, and a vent for removing depleted oxidant and water from the outlets of the channels.

It is to be appreciated that the use of hydrogen as a fuel and oxygen as an oxidizer are merely exemplary. Other suitable fuels would include methanol. Also, air may be a suitable oxidizer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic drawing of a fuel cell of the present invention connected with an external circuit;

FIG. 2 is an exploded perspective view of the component elements of the body of the fuel cell;

FIG. 3 is a cross-sectional view of a portion of the electrolyte of the fuel cell as seen along the line 3-3 in FIG. 2; and

FIG. 4 is a cross-sectional view of a portion of an electrode (the anode is only exemplary) of the fuel cell as seen along the line 4-4 in FIG. 2.

### DESCRIPTION OF THE PREFERRED EMBODIMENTS

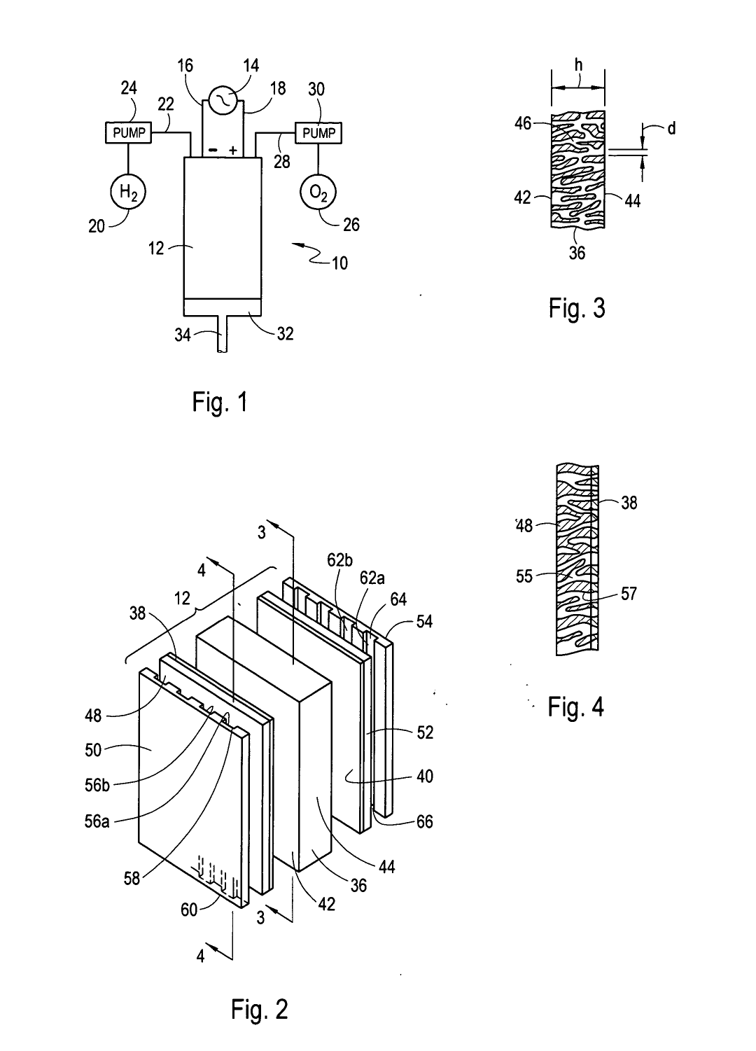

Referring initially to FIG. 1, a fuel cell in accordance with the present invention is shown and generally designated 10. As shown, the fuel cell 10 includes a cell body 12 that is electrically connected to an external circuit 14. More specifically, the external circuit 14 is electrically connected via a line 16 to an anode of the fuel cell 10, and it is also electrically connected via a line 18 to a cathode of the fuel cell 10. FIG. 1 also shows that the fuel cell 10 includes a fuel source 20 that is connected in fluid communication with the cell body 12 via a fluid line 22. A pump 24 may be included in this fluid connection with the fluid line 22 to control the flow of fuel from the fluid source 20 to the cell body 12. Preferably, the fuel that is held in the fuel source 20, for use by the fuel cell 10 of the present invention, is hydrogen gas (H₂). Further, FIG. 1 shows that the fuel cell 10 also includes an oxidant source 26 that is connected in fluid communication with the cell body 12 via a fluid line 28. A pump 30 may be included in this fluid connection to control the flow of oxidant from the oxidant source 26 to the cell body 12 of the fuel cell 10. Preferably, the oxidant that is used by the fuel cell 10 of the present invention is oxygen gas (O₂).

Still referring to FIG. 1, the fuel cell 10 is shown to include a container 32 for collecting depleted fuel and oxidant during the operation of the fuel cell 10. Further, an exhaust 34 is also shown for venting the depleted fuel and oxidant as desired. As envisioned for the present invention, incorporation of the container 32 is optional, and a pump (not shown) may be connected in fluid communication with the exhaust 34 to assist in removal of the depleted fuel and oxidant. The specific structure of the cell body 12 itself will be best appreciated with reference to FIG. 2.

In FIG. 2, it will be seen that the cell body 12 includes an electrolyte 36 that is formed as a thin plate-like structure. Preferably, the electrolyte 36 is made of an electro-osmotic material such as a porous silica that is formed with a plurality of pores 46 (see FIG. 3). As best seen in FIG. 3, the pores 46 provide fluid pathways between the sides 42 and 44 of the plate-like electrolyte 36. Importantly, for the present invention, the pores 46 are filled with water. For purposes of the present invention, the electrolyte 36 is manufactured to have a thickness “h” between side 42 and side 44 that is approximately fifty microns (h=50 μm). Additionally, the pores 46 of the porous silica material of the electrolyte 36 are formed to have a pore size (i.e. diameter) of about ten nanometers (2d=10 nm).

Referring now back to FIG. 2, it is seen that the cell body 12 also includes an anode 48 that includes a catalytic coating 38 that is positioned against a surface of the anode 48. FIG. 2 further shows that the cell body 12 includes a metal plate 50. Similarly, the cell body 12 includes a cathode 52 that includes a catalytic coating 40 and a metal plate 54. For purposes of the present invention, both anode 48 and cathode 52 are made of a porous conductive material, such as carbon or silicon, and are formed as plate-like structures. Unlike the electrolyte 36, however, the anode 48 and cathode 52 are hydrophobic and are not filled with water.

Referring to FIG. 4, a cross-sectional view of a portion of the anode 48 is shown with the catalytic coating 38 (preferably Platinum) positioned against a surface of the anode 48. Recall, the anode 48 is preferably made of a conductive material such as silicon or carbon, and is hydrophobic. Further, as shown in FIG. 4, the anode 48 is porous and is formed with a plurality of pores 55. As also shown in FIG. 4, the pores 55 extend through the material of anode 48, and through the catalytic coating 38. Consequently, when the anode 48 is positioned against side 42 of the electrolyte 36, with the catalytic coating 38 therebetween, many pores 55 of the anode 48 will be in fluid communication with as many pores 46 of the electrolyte 36.

Structurally, the cathode 52 and its catalytic coating 40, in combination, are essentially similar, in both the material and functional respects, to the combination of the anode 48 and its catalytic coating 38 disclosed above. Specifically, pores in the cathode 52 are in fluid communication, through its catalytic coating 40, with the pores 46 of the electrolyte 36, just as are the pores 55 of anode 48. Unlike the electrolyte 36, however, the pores 55 of the anode 48 and the respective pores of the cathode 52 are not filled with water. Consequently, within the cell body 12, at both the anode 48 and the cathode 52 (the location 57 in the anode 48 that is shown in FIG. 4 is only exemplary), water from pores 46 of the electrolyte 36 is exposed as it comes into contact with the catalytic coating 38 of anode 48 and catalytic coating 40 in cathode 52.

Returning to FIG. 2 it will also be seen that the metal plate 50 is formed with a plurality of elongated channels 56 that are mutually parallel and extend along the length of the metal plate 50 (the channels 56a and 56b are only exemplary). As an example of the channels 56 that are formed into the metal plate 50, the channel 56a is shown with an inlet 58 and an outlet 60. Thus, a fluid fuel (e.g. hydrogen gas) is able to flow through the channel 56a from the fuel source 20 to the exhaust 34. Importantly, as the fluid fuel flows through the channel 56a it will come in contact with the anode 48 and pass through the pores 55 toward the electrolyte 36 (e.g. location 57). Further, insofar as the cathode 52 is concerned, FIG. 2 shows that the metal plate 54 is formed with a plurality of elongated channels 62 (again, the channels 62a and 62b are only exemplary). Like the channels 56, the channels 62 are mutually parallel and extend along the length of the metal plate 54. Exemplary of the channels 62 that are formed into the metal plate 54, the channel 62a is shown with an inlet 64 and an outlet 66 that will allow a fluid oxidant (e.g. oxygen gas) to flow through the channel 62a from the oxidant source 26 to the exhaust 34. Importantly, as the fluid oxidant flows through the channel 62a it will come into contact with the cathode 52 and pass through pores in the cathode 52 toward the electrolyte 36.

As envisioned for the present invention, the electrolyte 36 can be manufactured in any of several ways. These include: 1) sintering particulates or clusters of silica; 2) pyrolizing a low dielectric constant material that has been coated with polymethylsilsesquioxane; 3) weaving silica fibers; 4) bombarding a solid silica plate with nuclear fission fragments; or 5) using a micro bubble technique as disclosed in U.S. Pat. No. 5,763,017, which issued to Ohkawa for an invention entitled “Method for Producing Micro-Bubble Textured Material,” and which is assigned to the same assignee as the present invention. Regardless which method of manufacture is used, the result needs to be a porous silica material that has properly sized pores 46 (i.e. pore diameter of around 10 nm).

With the above in mind, it is important to realize that if the fuel can pass through the electrolyte 36 and reach the cathode 52, it will be oxidized by the oxidant (e.g. oxygen) without generating an electric current. For gas fuel, such as hydrogen, the specific concern is that the gas can reach the cathode 52 as gas bubbles or by the diffusion of dissolved gas. Insofar as the production of bubbles is concerned, the minimum gas pressure for preventing bubble growth depends on the diameter of the bubble. This is so because the gas pressure inside of the bubble must be in equilibrium with the surface tension of water. The force balance in this case is given by the expression
p=2γ/r
where p is the gas pressure, γ is the surface tension of water and r is the radius of the bubble. For a given ambient gas pressure, the bubble must grow on a solid surface to the size given by the above equation to survive.

At the interface between the water and the porous silica of the electrolyte 36, the potential bubble radius is limited to half the pore size “d” of the pores 46. Therefore bubbles will not form if
d<r=2γ/p

Knowing that the value of γ at 80° C. is γ=6.3×10⁻³ N/m, it can be shown that at p=1 atm=10⁵ N/m², the above condition becomes d<1.3×10⁻⁷ m. Thus, if the pressure is higher, the pore size is proportionally smaller. For d=5 nm, the limit on the pressure is 25 atm.

The solubility of gas is customarily expressed by the variable α, which is defined as the ratio of the volume of the dissolved gas in the standard condition to the volume of water. The number density of the dissolved gas molecule n_{g} is then given by
n_{g}=α×2.7×10²⁵ m⁻³

For the value of α for hydrogen at 80° C. (α=1.6×10⁻²) and the number density of the dissolved gas is n_{g}=4.3×10²³ m⁻³ and the concentration of hydrogen at the cathode 52 is negligibly small. If the distance between the anode 48 and the cathode 52 is “h,” the flux of hydrogen Γ reaching the cathode 52 is given by
Γ=Dn_{g}/h
where D is the diffusion constant. We can then compare the hydrogen flux through the electrolyte 36 with the proton flux, namely the current density. By using D=10⁻⁹ m²/s and h=10⁻⁴ m, the hydrogen flux is r=4.3×10¹⁸/m²s. On the other hand, a typical current density of 10⁴ A/m² corresponds to a proton flux of 6.8×10²²/m²s. Thus, the proton flux associated with the current is much greater than the hydrogen flux due to diffusion.

In the operation of an SEFC fuel cell 10 according to the present invention, a fluid fuel (e.g. hydrogen gas) is pumped from the fuel source 20 to the inlet 58 of a channel 56 in metal plate 50. The hydrogen then passes through the channel 56 and comes into contact with the anode 48. In the anode 48 (e.g. location 57), the hydrogen undergoes an electrochemical reaction with water at the catalytic coating 38 and is converted to protons and free electrons. The resultant proton concentration gradient transports the protons through the electrolyte 36 toward the cathode 52. The free electrons then flow from the anode into the external circuit 14. At the same time, a fluid oxidant (e.g. oxygen gas) is being pumped from the oxidant source 26 to the inlet 64 of a channel 62 in metal plate 54. This oxygen then passes through the channel 62 and comes into contact with the cathode 52. At the catalytic coating 40 in the cathode 52, the protons from the electrolyte 36 and electrons from the external circuit 14 combine with the oxygen in another electrochemical reaction to produce water. Meanwhile, the consequence of these electrochemical reactions at the anode 48 and cathode 52 is that the electrons flow from the anode 48 to the cathode 52 as an electrical current to provide electrical energy for the external circuit 14.

While the particular Surface Electrolyte for Fuel Cell (SEFC) as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A fuel cell which comprises:
a water-filled porous, electro-osmotic material for creating an electrolyte, wherein said electrolyte is formed as a plate-like structure having a first side and a second side;
an anode positioned against the first side of said electrolyte plate;
a cathode positioned against the second side of said electrolyte plate;
a fuel source for directing a fuel against said anode to generate positive ions for transport thereof through said electrolyte plate to said cathode; and
an oxidant source for directing an oxidant against said cathode to oxidize the positive ions and create an electrical potential between said anode and said cathode for the production of electrical energy.

2. A fuel cell as recited in claim 1 further comprising:
a first platinum coating positioned between the first side of said electrolyte plate and said anode; and
a second platinum coating positioned between the second side of said electrolyte plate and said cathode.

3. A fuel cell as recited in claim 1 wherein the material of said electrolyte plate is porous silica having pore sizes of approximately 10 nm diameter.

4. A fuel cell as recited in claim 1 wherein said anode and said cathode are made of porous silicon.

5. A fuel cell as recited in claim 1 wherein said fuel source comprises:
a metal plate formed with at least one channel, wherein the channel has an inlet and an outlet, said metal plate being positioned against said anode with the channel therebetween and with said anode between said metal plate and said electrolyte plate;
a means for introducing the fuel into the channel through the inlet of the channel; and
a means for removing depleted fuel from the outlet of the channel.

6. A fuel cell as recited in claim 1 wherein said oxidant source comprises:
a metal plate formed with at least one channel, wherein the channel has an inlet and an outlet, said metal plate being positioned against said cathode with the channel therebetween and with said cathode between said metal plate and said electrolyte plate;
a means for introducing the oxidant into the channel through the inlet of the channel; and
a means for removing depleted oxidant and water from the outlet of the channel.

7. A fuel cell as recited in claim 1 wherein the fuel is hydrogen gas.

8. A fuel cell as recited in claim 1 wherein the oxidant is oxygen gas.

9. A fuel cell as recited in claim 1 wherein said electrolyte plate has a thickness “h”, and the thickness “h” is greater than approximately fifty microns.

10. An electrolyte structure for use in a fuel cell which comprises:
a porous silica material formed as an electrolyte plate having a first side and a second side with a thickness “h” therebetween, wherein the silica material has a plurality of pores extending therethrough from the first side to the second side, with each pore having a pore size of approximately ten nanometers diameter, and further wherein the thickness “h” of the electrolyte plate is approximately fifty microns; and
water filling the pores of the silica material.

11. A structure as recited in claim 10 wherein the fuel cell is monolithic and comprises:
an anode positioned against the first side of said electrolyte plate with a first platinum coating positioned therebetween, wherein the anode is made of a porous silicon material;
a cathode positioned against the second side of said electrolyte plate with a second platinum coating positioned therebetween, wherein the cathode is made of a porous silicon material;
a fuel source for directing a fuel against said anode to generate positive ions for transport thereof through said electrolyte plate to said cathode; and
an oxidant source for directing an oxidant against said cathode to oxidize the positive ions and create an electrical potential between said anode and said cathode for the production of electrical energy.

12. A structure as recited in claim 11 wherein the fuel is hydrogen gas and the oxidant is oxygen gas.

13. A structure as recited in claim 11 wherein said fuel source comprises:
a metal plate formed with at least one channel, wherein the channel has an inlet and an outlet, said metal plate being positioned against said anode with the channel therebetween and with said anode between said metal plate and said electrolyte plate;
a pumping means for introducing the fuel into the channel through the inlet of the channel; and
a venting means for removing depleted fuel from the outlet of the channel.

14. A structure as recited in claim 11 wherein said oxidant source comprises:
a metal plate formed with at least one channel, wherein the channel has an inlet and an outlet, said metal plate being positioned against said cathode with the channel therebetween and with said cathode between said metal plate and said electrolyte plate;
a pumping means for introducing the oxidant into the channel through the inlet of the channel; and
a venting means for removing depleted oxidant and water from the outlet of the channel.

15. A method for producing electrical energy which comprises the steps of:
providing a monolithic fuel cell having an electrolyte positioned between an anode and a cathode, wherein the electrolyte is made of a porous, electro-osmotic material and is formed as a plate-like structure having a first side and a second side, and further wherein the anode is positioned against the first side of said electrolyte plate with a first platinum coating therebetween, and the cathode is positioned against the second side of said electrolyte plate with a second platinum coating therebetween;
filling pores of the electrolyte plate with water;
directing a fuel against the anode to generate positive ions for transport thereof through the electrolyte plate to the cathode; and
directing an oxidant against the cathode to oxidize the positive ions and create an electrical potential between the anode and the cathode for the production of electrical energy.

16. A method as recited in claim 15 wherein the material of said electrolyte plate is porous silica having pore sizes of approximately 10 nm diameter and the electrolyte plate has a thickness “h”, with the thickness “h” being greater than approximately fifty microns.

17. A method as recited in claim 15 wherein the anode and the cathode are made of porous silicon.

18. A method as recited in claim 15 wherein the fuel directing step is accomplished using a fuel source which comprises:
a metal plate formed with at least one channel, wherein the channel has an inlet and an outlet, the metal plate being positioned against the anode with the channel therebetween and with the anode located between the metal plate and the electrolyte plate;
a pumping means for introducing the fuel into the channel through the inlet of the channel; and
a venting means for removing depleted fuel from the outlet of the channel.

19. A method as recited in claim 15 wherein the oxidant directing step is accomplished using an oxidant source which comprises:
a metal plate formed with at least one channel, wherein the channel has an inlet and an outlet, said metal plate being positioned against the cathode with the channel therebetween and with the cathode located between the metal plate and the electrolyte plate;
a pumping means for introducing the oxidant into the channel through the inlet of the channel; and
a venting means for removing depleted oxidant and water from the outlet of the channel.

20. A method as recited in claim 15 wherein the fuel is hydrogen gas and the oxidant is oxygen gas.
